(19) United States
(12) Patent Application Publication
(10) Pub. No.: US 2026/0239344 A1
(43) Pub. Date: Aug. 13, 2026

(54) SYSTEMS AND METHODS FOR INFORMATION TRANSMISSION

(71) Applicant: ZTE CORPORATION, Shenzhen (CN)

(72) Inventors: Shuaihua KOU, Shenzhen (CN); Jing SHI, Shenzhen (CN); Xianghui HAN, Shenzhen (CN); Peng HAO, Shenzhen (CN); Wei GOU, Shenzhen (CN); Xing LIU, Shenzhen (CN)

(21) Appl. No.: 19/156,269

(22) PCT Filed: Feb. 22, 2023
(86) PCT No.: PCT/CN2023/077691

§ 371 Date: Aug. 13, 2025

(51) Int. Cl. H04W 72/20; H04L 1/1812; H04W 72/0446; H04W 72/0453; H04W 72/12

(52) U.S. Cl. CPC H04W 72/20; H04L 1/1812; H04W 72/0446; H04W 72/0453; H04W 72/12

(57) ABSTRACT

The present arrangement relates to systems, methods, and non-transitory computer-readable media for receiving a CI message, the CI message configured to indicate whether a data channel carries first data for a first wireless communication device or second data for a second wireless communication device.

### CROSS-REFERENCE TO RELATED APPLICATION

This application is a national stage filing under 35 U.S.C. § 371 of international application number PCT/CN2023/077691 filed Feb. 22, 2023. The contents of this application is incorporated herein by reference in its entirety.

### TECHNICAL FIELD

The disclosure relates generally to wireless communications and, more particularly, to control information (CI) and data communication.

### BACKGROUND

In 5^{th} Generation Mobile Network System (5GC), CI and data are key technologies in new radio (NR) systems. Downlink and uplink features may include wireless communications between user equipment (UE) and network. Sidelink features may include wireless communications between user equipment (UEs).

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

In some arrangements, a first wireless communication device can receive a message comprising control information (CI) to schedule a data channel for the first wireless communication device from a wireless communication node. The CI is configured to indicate whether the data channel carries first data for the first wireless communication device or second data for a second wireless communication device.

In some arrangements, a wireless communication node can send a message comprising CI to schedule a data channel for a first wireless communication device to the first wireless communication device. The CI is configured to indicate whether the data channel carries first data for the first wireless communication device or second data for a second wireless communication device.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example wireless communication system, according to some arrangements.

FIG. 2 illustrates block diagrams of an example base station and an example user equipment device, according to some arrangements.

FIG. 3 is a diagram illustrating an example wireless communication system, according to various arrangements.

FIG. 4 is a diagram illustrating an example wireless communication system, according to various arrangements.

FIG. 5 is a diagram illustrating an example physical uplink shared channel (PUSCH) transmission, according to various arrangements.

FIG. 6 is a diagram illustrating an example control information (CI), according to various arrangements.

FIG. 7 is a diagram illustrating an example physical downlink shared channel (PDSCH) scheduling, according to various arrangements.

FIG. 8 is a flowchart diagram illustrating an example method for information transmission, according to various arrangements.

FIG. 9 is a flowchart diagram illustrating an example method for information transmission, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

In a wireless communications system, a wireless device (e.g., a first user equipment (UE)) may communicate with a network. As part of the communication, the first UE may have a transmission requirement that is above a supported threshold (e.g., higher than what it can support). In this case, another UE may help the first UE with data transmission if the two UEs support and can perform transmission between each other (e.g., sidelink communication). This may improve data rate and reliability via data split and duplication, respectively. However, this may also significantly increase the cost of air interface resources. The arrangement disclosed herein provides enhancements (e.g., additions, updates, changes) to the system (e.g., a second UE supporting transmission of a first UE), for example, to control information (CI) (e.g., downlink CI (DCI), sidelink CI (SCI)), hybrid automatic repeat-request (HARQ) feedback, data channels, or any combination thereof, among other aspects of the system. To do so, wireless communications systems may support a CI that schedules at least a data channel for a UE, in which the CI indicates whether the data channel carries the data of the UE or carries the data of another UE.

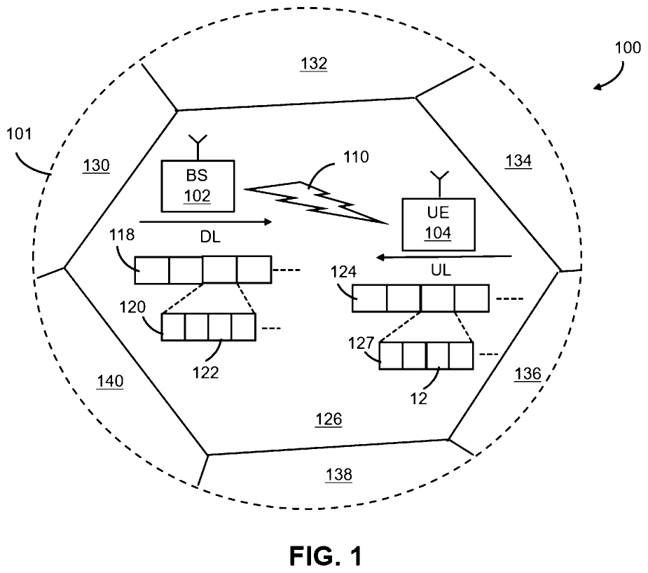

FIG. 1 illustrates an example wireless communication system 100 in which techniques disclosed herein may be implemented, in accordance with an implementation of the present disclosure. In the following discussion, the wireless communication system 100 can implement any wireless network, such as a cellular network or a narrowband Internet of things (NB-IoT) network, and is herein referred to as system 100. Such an example system 100 includes a BS 102 and a UE 104 that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one BS operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various implementations of the present solution.

In some implementations, the wireless communication system 100 may support CI (e.g., DCI or SCI) and data communication. For example, CI communication is a key technology in new radio (NR) systems. Data transmission technologies may include uplink, downlink, and sidelink data transmissions over a data channel. For transmitting the data, a wireless communication device may be configured with resources via one or more control messages (e.g., DCI or SCI). The techniques described herein may provide enhancements to various aspects of the data transmission and CI process. For example, a first wireless communication device may receive, from a wireless communication node, a message including CI to schedule a data channel for the first wireless communication device. The CI may be configured to indicate whether the data channel carries first data for the first wireless communication device or second data for a second wireless communication device.

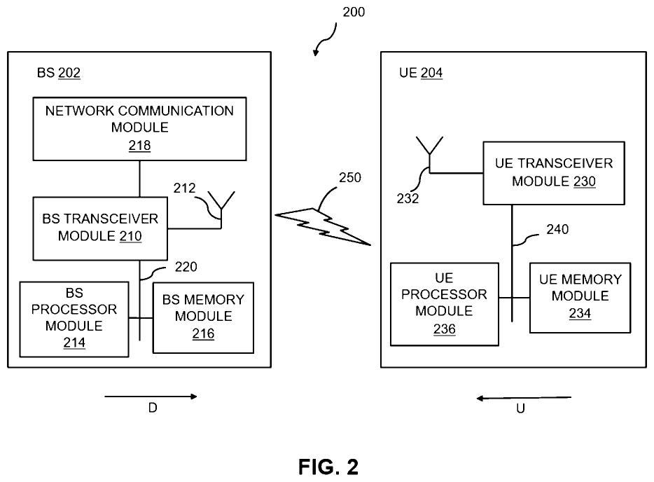

FIG. 2 illustrates a block diagram of an example wireless communication system 200 for transmitting and receiving wireless communication signals, e.g., OFDM/OFDMA signals, in accordance with some implementations of the present solution. The system 200 may include components and elements configured to support known or conventional operating features that need not be described in detail herein. In one illustrative implementation, system 200 can be used to communicate (e.g., transmit and receive) data symbols in a wireless communication environment such as the wireless communication environment 100 of FIG. 1, as described above.

System 200 generally includes a BS 202 and a UE 204. The BS 202 includes a Base Station (BS) transceiver module 210, a BS antenna 212, a BS processor module 214, a BS memory module 216, and a network communication module 218, each module being coupled and interconnected with one another as necessary via a data communication bus 220. The UE 204 includes a UE transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

The system 200 may further include any number of modules other than the modules shown in FIG. 2. Those skilled in the art will understand that the various illustrative blocks, modules, circuits, and processing logic described in connection with the implementations disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some implementations, the UE transceiver 230 may be referred to herein as an uplink transceiver 230 that includes a Radio Frequency (RF) transmitter and a RF receiver each including circuitry that is coupled to the antenna 232. A duplex switch (not shown) may alternatively couple the uplink transmitter or receiver to the uplink antenna in time duplex fashion. Similarly, in accordance with some implementations, the BS transceiver 210 may be referred to herein as a “downlink” transceiver 210 that includes a RF transmitter and a RF receiver each including circuitry that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some implementations, there is close time synchronization with a minimal guard time between changes in duplex direction.

The UE transceiver 230 and the BS transceiver 210 are configured to communicate via the wireless data communication link 250, and cooperate with a suitably configured RF antenna arrangement 212/232 that can support a particular wireless communication protocol and modulation scheme. In some illustrative implementations, the UE transceiver 210 and the BS transceiver 210 are configured to support industry standards such as the Long Term Evolution (LTE) and emerging 5G and 6G standards, and the like. It is understood, however, that the present disclosure is not necessarily limited in application to a particular standard and associated protocols. Rather, the UE transceiver 230 and the BS transceiver 210 may be configured to support alternate, or additional, wireless data communication protocols, including future standards or variations thereof.

In accordance with various implementations, the BS 202 may be an evolved node B (eNB), a serving eNB, a target eNB, a femto station, or a pico station, for example. In some implementations, the UE 204 can be various types of user devices such as a mobile phone, a smart phone, a Personal Digital Assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the methods described in connection with the implementations disclosed herein may be implemented directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some implementations, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the BS 202 that enable bi-directional communication between BS transceiver 210 and other network components and communication nodes configured to communication with the BS 202. For example, network communication module 218 may be configured to support internet or WiMAX traffic. In a typical deployment, without limitation, network communication module 218 provides an 802.3 Ethernet interface such that BS transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

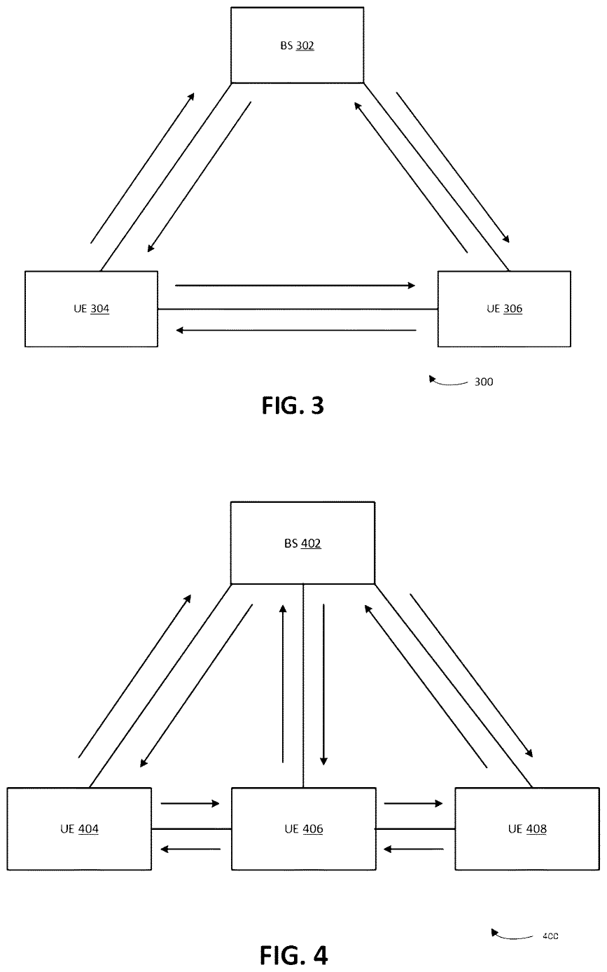

FIG. 3 is a diagram illustrating an example wireless communication system 300, according to various arrangements. The wireless communication system 300 may outline wireless communication between a network 302 (e.g., BS), a UE 304, and a UE 306. In some cases, the BS 302 may be in wireless communication with the UE 304 and the UE 306 and the UE 304 may be in wireless communication with the UE 306 (e.g., sidelink communication). In some examples, the UE 304 may also be referred to as a remote UE or anchor UE and the UE 306 may also be referred to as an aggregated UE. In some cases, a remote UE may be connected with more than one aggregated UEs. Additionally, or alternatively, an aggregated UE may be connected with more than one remote UEs. The remote UE may also be connected with the network for uplink data and downlink data transmissions.

In the wireless communication, the UE 306 may help the UE 304 transmit data (e.g., uplink data, downlink data, sidelink data, etc.). In some cases, the BS 302 may be another UE, such that the wireless communication system 300 includes three UEs. For example, when the UE 306 helps the UE 304 transmit sidelink data, the other UE may replace the BS 302. The UE 304 may be connected with the UE 306 for the data transmission (e.g., message) between each other. In a first example embodiment, for downlink transmissions, the network 302 may transmit downlink data associated with the UE 304 to the UE 306. The UE 306 may forward the received downlink data of the UE 304 to the UE 304. In a second example embodiment, for uplink transmissions, the UE 304 may transmit uplink data associated with the UE 304 to the UE 306. The UE 306 may forward (e.g., transmit, relay) the received uplink data of the UE 304 to the network 302.

In some embodiments, the network 302 may transmit a message including CI. For example, the network 302 may transmit CI (e.g., DCI or SCI) to a UE (e.g., the UE 304, the UE 306, or both). Alternatively, another UE may transmit CI (e.g., SCI) to a UE (e.g., the UE 304, the UE 306, or both). The CI may schedule one or more physical downlink shared channels (PDSCHs), one or more physical uplink shared channels (PUSCHs), or one or more physical sidelink shared channels (PSSCHs) for the UE. The CI may indicate the owner (e.g., the UE 304 or the UE 306) of the data carried by the scheduled PDSCHs or PUSCHs. For example, the CI may indicate which data is carried by the scheduled PDSCHs, PUSCHs, or PSSCHs (e.g., via an identifier). For instance, a first field of the CI, a radio network temporary identifier of the CI, a search space index of the CI, or a control resource set index of the CI may be used to indicate the owner of the data carried by the scheduled PDSCHs, PUSCHs, or PSSCHs. In some cases, owner may refer to the UE from which the data originates or is associated with.

In some cases, the UE 306 may be connected with more than one UE 304 (e.g., more than one remote UE). The CI (e.g., the first field included in the CI, the radio network temporary identifier of the CI, the search space index of the CI, or the control resource set index of the CI) may further indicate for which remote UE is the data carried by the scheduled PDSCHs, PUSCHs, or PSSCHs.

In some examples, a CI for the UE 306 may be scrambled by radio network temporary identifier one (RNTI 1) and RNTI 2. The CI being scrambled by the RNTI 1 may indicate that the scheduled PDSCH, PUSCH, or PSSCH carry data of the UE 304. For example, the CI may be scrambled by RNTI 1 such that the data carried by the scheduled PDSCH, PUSCH, or PSSCH may belong to the UE 304. The CI being scrambled by the RNTI 2 may indicate that the scheduled PDSCH, PUSCH, or PSSCH may carry data of the UE 306. For example, the CI may be scrambled by RNTI 2 such that the data carried by the scheduled PDSCH, PUSCH, or PSSCH may belong to the UE 306.

FIG. 4 is a diagram illustrating an example wireless communication system 400, according to various arrangements. The wireless communication system 400 may outline wireless communication between a network 402 (e.g., BS), a UE 404, a UE 406, and a UE 408. In some cases, the network 402 may be in wireless communication with the UE 404, the UE 406, and the UE 408; the UE 404 may be in wireless communication with the UE 406 (e.g., sidelink communication); and the UE 406 may be in wireless communication with the UE 408. In some examples, the UE 404 and the UE 408 may also be referred to as remote UEs or anchor UEs and the UE 406 may also be referred to as an aggregated UE.

In some cases, the UE 406 may serve both the UE 404 and the UE 408. The network may transmit a CI (e.g., DCI or SCI) message to the UE 406. In some examples, the CI message for the UE 406 may include a first field for indicating the owner of the data carried by the PDSCH, PUSCH, or PSSCH. The first field may include two bits indicating various mappings. For example, the value ‘00’ may indicate that the PDSCH, or PUSCH, or PSSCH scheduled by the CI may carry the data of UE 406. The value ‘01’ may indicate that the PDSCH, or PUSCH, or PSSCH scheduled by the CI may carry the data of UE 404. The value ‘10’ may indicate that the PDSCH, or PUSCH, or PSSCH scheduled by the CI may carry the data of UE 408. While the mappings of 00, 01, and 10 are given as examples, other mappings are possible and may depend on a number of remote UEs and/or aggregate UEs.

In some examples, for the UE 406, the CI may indicate that the scheduled PDSCH carries downlink data for a remote UE (e.g., the UE 404 or the UE 408). The UE 406 may receive the PDSCH and decode a transport block carried by the PDSCH. The decoded transport block may be delivered to the remote UE. For example, the UE 406 may transmit the transport block to the remote UE after successfully decoding the transport block of the data channel. Alternatively, the CI may indicate that the scheduled PDSCH carries downlink data of the UE 406. A transport block may be delivered to the higher layer of the UE 406 after being decoded. For example, the UE 406 may send the decoded transport block to the higher layer of the UE 406 after successfully decoding the transport block of the data channel.

In some cases, for the UE 406, the CI may indicate that the scheduled PUSCH carries uplink data of a remote UE (e.g., second data for a second wireless communication device). The UE 406 may request the remote UE (e.g., the UE 404 or the UE 408) to generate (e.g., assemble) a transport block (or medium access control (MAC) protocol data unit (PDU)) for the scheduled PUSCH (e.g., for the data channel). The UE 406 may send at least the time domain information of the scheduled PUSCH to the remote UE. The time domain information of the PUSCH may include at least one of resource location and resource size. The resource location may include at least one of orthogonal frequency division multiplex (OFDM) symbol number, the slot number, sub-frame number, and system frame number. The resource size may include at least the number of orthogonal frequency division multiplex (OFDM) symbols occupied by the scheduled PUSCH. The remote UE may send the transport block (or MAC PDU) for the scheduled PUSCH to the UE 406. Alternatively, the CI may indicate that the scheduled PUSCH carries uplink data of the UE 406. The UE 406 may generate a transport block (or MAC PDU) for the scheduled PUSCH. In either case, the UE 406 may transmit the PUSCH carrying the transport block (or MAC PDU) to the network 402 (e.g., BS).

In some embodiments, for the UE 406, the CI may indicate that the scheduled PSSCH carries sidelink data for a remote UE (e.g., the UE 404 or the UE 408). The UE 406 may receive the PSSCH and decode a transport block carried by the PSSCH. The decoded transport block may be delivered to the remote UE. Alternatively, the CI may indicate that the scheduled PSSCH carries sidelink data of the UE 406. A transport block may be delivered to the higher layer of the UE 406 after being decoded.

In some cases, for the UE 406, the CI may indicate that the scheduled PSSCH carries sidelink data of a remote UE (e.g., the UE 404 or the UE 408). The UE 406 may request the remote UE (e.g., the UE 404 or the UE 408) to generate (e.g., assemble) a transport block (or MAC PDU) for the scheduled PSSCH. The UE 406 may send at least the time domain information of the scheduled PSSCH to the remote UE. The time domain information of the PSSCH may include at least one of resource location and resource size. The resource location may include at least one of OFDM symbol number, the slot number, sub-frame number, and system frame number. The resource size may include at least the number of orthogonal frequency division multiplex (OFDM) symbols occupied by the scheduled PSSCH. The remote UE may send the transport block (or MAC PDU) for the scheduled PSSCH to the UE 406. Alternatively, the CI may indicate that the scheduled PSSCH carries sidelink data of the UE 406. The UE 406 may generate a transport block (or MAC PDU) for the scheduled PSSCH. In either case, the UE 406 may transmit the PSSCH carrying the transport block (or MAC PDU) to another UE.

In some examples, the network 402 may configure a configuration for a logical channel for one or more of the UEs (e.g., the UE 404, the UE 406, the UE 408). The configuration may include an allowed data type. In some cases, a logical channel may be configured with more than one allowed data types. The data type may include data of a remote UE (e.g., the UE 404 or the UE 408), or data of an aggregated UE (e.g., the UE 406). The network 402 may schedule a data channel (e.g., PUSCH or physical sidelink shared channel (PSSCH)) for the UE. The network 402 may configure the carried data types for the data channel (e.g., PUSCH or PSSCH).

The UE may select one or more logical channels that satisfy the carried data types for the data channel. For example, the allowed data types of the logical channel may match the carried data types of the data channel. The data of the selected logical channels may be mapped to (e.g., carried by) the data channel (e.g., PUSCH or PSSCH). The data type may be indicated (e.g., reflected) by the RNTI, the first field, the search space index, the control resource set index of the CI. For example, the network 402 may configure the allowed RNTI, allowed value of the first field, allowed search space index, and/or allowed control resource set index for the logical channel.

In some cases, the network 402 may configure an allowed RNTI value for the logical channel. For example, the configured allowed RNTI may be a first RNTI for the first logical channel. The configured allowed RNTI may be a second RNTI for the second logical channel. In some cases, the first logical channel may be selected for a first data channel (e.g., PUSCH or PSSCH) scheduled by a first CI scrambled with the first RNTI. The data of the first logical channel may be mapped to (e.g., carried by) the first data channel. In some cases, the second logical channel may be selected for a second data channel (e.g., PUSCH or PSSCH) scheduled by a second CI scrambled with the second RNTI. The data of the second logical channel may be mapped to (e.g., carried by) the second data channel.

In some examples, the network 402 may configure more than one allowed RNTI values for the logical channel. The logical channel may be selected for the data channel (e.g., PUSCH or PSSCH) scheduled by a CI scrambled with any one of the more than one allowed RNTI values. For a third logical channel, the configured allowed RNTI may be a third RNTI and a fourth RNTI. For a third data channel (e.g., PUSCH or PSSCH) scheduled by a CI scrambled with a third RNTI or fourth RNTI, the third logical channel may be selected. The data of the third logical channel may be mapped to (e.g., carried by) the third data channel.

In some cases, the UE 406 may be configured with five logical channels, denoted by LCH 1, LCH 2, LCH 3, LCH 4, and LCH 5 respectively. The network 402 may configure an allowed value of the first field for some logical channels. For example, the allowed value of the first field may include ‘00’ for LCH 1. The allowed value of the first field may include ‘00’ for LCH 2. The allowed value of the first field may include ‘01’ and/or ‘10’ for LCH 3. The allowed value of the first field may include ‘10’ for LCH 4. While the mappings of 00, 01, and 10 are given as examples, other mappings are possible and may depend on a number of remote UEs and/or aggregate UEs. In some cases, the network 402 may not configure an allowed value of the first field for LCH 5. For example, LCH 5 may be selected for any PUSCH or PSSCH and the data of LCH 5 may be mapped to any PUSCH or PSSCH.

In some cases, LCH 1, LCH 2 and LCH 5 may be selected for the PUSCH or PSSCH scheduled by a CI that includes the first field with value ‘00’. The data of LCH 1, LCH 2 and/or LCH 5 may be mapped to the PUSCH or PSSCH. LCH 3 and LCH 5 may be selected for the PUSCH or PSSCH scheduled by a CI that includes the first field with value ‘01’. The data of LCH 3 and/or LCH 5 may be mapped to the PUSCH or PSSCH. LCH 3, LCH 4 and LCH 5 may be selected for the PUSCH or PSSCH scheduled by a CI that includes the first field with value ‘10’. The data of LCH 3, LCH 4 and/or LCH 5 may be mapped to the PUSCH or PSSCH.

In some embodiments, a remote UE (e.g., the UE 404 or the UE 408) may send a transport block (or MAC PDU) for the scheduled PUSCH or PSSCH to the UE 406. For each transport block (or MAC PDU) delivered from the remote UE to the UE 406, the UE 406 may send the remote UE a transmission report indicating whether the transport block (or MAC PDU) was successfully delivered. The remote UE may store the transport block (or MAC PDU) in the buffer until receiving the transmission report indicating that the transport block (or MAC PDU) has been delivered successfully or receiving a new scheduling with the HARQ process corresponding to the transport block (or MAC PDU). In some cases, the UE 406 may send the transmission report indicating that a transport block (or MAC PDU) is not successfully delivered or the UE 406 may not send any transmission report for a transport block (or MAC PDU). Such transport block (or MAC PDU) may be referred to as an undelivered transport block (or MAC PDU).

In some cases, the remote UE may send the undelivered transport block (or MAC PDU) to the network 402 or another UE. In some embodiments, a first HARQ process of the remote UE may be associated with (e.g., correspond to) a second HARQ process of the aggregated UE (e.g., UE 406). The network 402 may configure such an association. A CI may schedule a PDSCH, PUSCH or PSSCH with the first HARQ process for the remote UE. The CI may indicate whether the scheduled PDSCH, PUSCH or PSSCH carries the undelivered transport block. The undelivered transport carried by the PDSCH, PUSCH or PSSCH may have the second HARQ process of a previous transmission in the UE 406. For example, a second field in the CI may indicate whether the scheduled PDSCH, PUSCH or PSSCH carries the undelivered transport block. In some cases, the second field may be configured to indicate to the remote UE to retransmit a transport block through the data channel, the transport block being delivered to the remote UE from the UE 406.

For example, the second field may include one bit with value ‘0’ indicating that the PDSCH, PUSCH or PSSCH does not carry the undelivered transport block. The remote UE may retransmit the transport block (or MAC PDU) corresponding to the first HARQ process or transmit a new transport block (or MAC PDU) corresponding to the first HARQ process. The value ‘1’ of the second field may indicate that the PDSCH, PUSCH or PSSCH carries the undelivered transport block with the second HARQ process. The remote UE may retransmit the transport block (or MAC PDU) corresponding to the second HARQ process. Alternatively, the remote UE may regenerate a new transport block (or MAC PDU) to include the data carried in the undelivered transport block (or MAC PDU). The new generated transport block may be sent by the remote UE to the network or another UE.

In some embodiments, the CI may schedule a data channel for UE 406. The CI may indicate that the data channel carries the data of the UE 406. A specific time interval may be for the data channel carrying the data of UE 406. The interval between the CI (e.g., the last symbol of the physical control channel (PDCCH) or physical sidelink control channel (PSCCH) carrying the CI) and the data channel (e.g., the first symbol of the data channel) that carries the data of UE 406 may be equal to or larger than the specific time interval. The specific time interval may be specified by the protocol or indicated by network 402.

An additional time interval may be reported by the UE (e.g., UE 406, 404, or 408). The additional time interval may be for the data channel carrying the data for a remote UE (e.g., the UE 404, or the UE 408). The interval between the CI (e.g., the last symbol of the PDCCH or PSCCH carrying the CI) and the data channel (e.g., the first symbol of the data channel) that carries the data for a remote UE (e.g., the UE 404, or the UE 408) may be equal to or larger than the sum of the specific time interval and the reported additional time interval.

For example, the specific time interval is N1 symbols and the additional time interval is N2 symbols. When the CI indicates that the scheduled data channel carries the data of the UE 406, the interval between the last symbol of the PDCCH or PSCCH carrying the CI and the first symbol of the scheduled data channel may be equal to or larger than N1 symbols. When the CI indicates that the scheduled data channel carries the data of a remote UE (e.g., the UE 404, or the UE 408), the interval between the last symbol of the PDCCH or PSCCH carrying the CI and the first symbol of the scheduled data channel may be equal to or larger than (N1+N2) symbols.

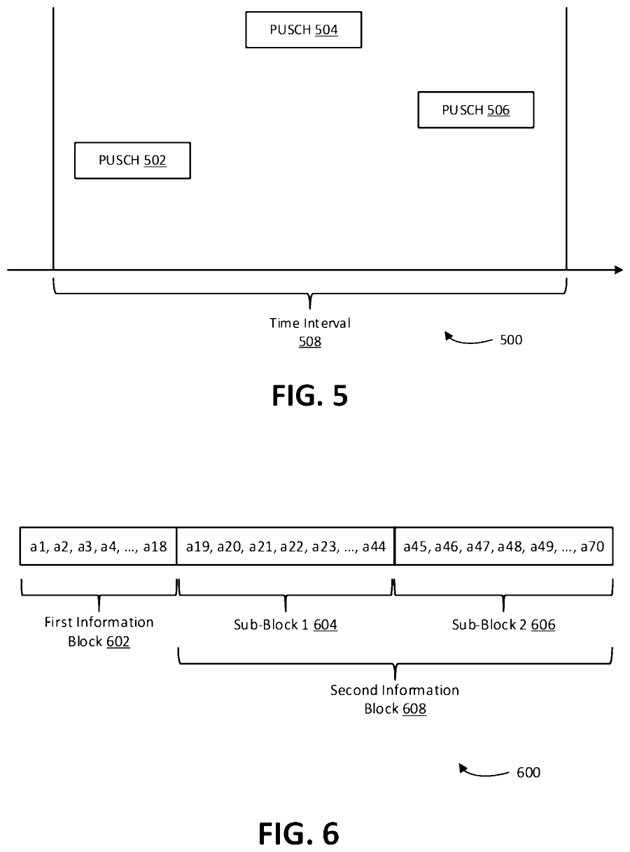

FIG. 5 is a diagram illustrating an example PUSCH transmission 500, according to various arrangements. The transmission 500 may include a first PUSCH 502, a second PUSCH 504, and a third PUSCH 506. In some cases, the PUSCHs 502, 504, and 506 may be transmitted during a time interval 508. A network and a UE as referred to herein may be respective examples of a network 402 and a UE 404, 406, or 408, as described with reference to FIG. 4.

In some embodiments, the network may transmit a CI (e.g., DCI or SCI) to a UE (e.g., the remote UE or the aggregated UE). The CI may schedule at least one PDSCH or PSSCH for the UE. In some examples, the CI may indicate that the data channel carries data for the UE (e.g., second data). In a first example, the UE may send PUCCH to the network (e.g., a wireless communication node) only when a HARQ-ACK information bit corresponding to the at least one data channel has an ACK value. In a second example, the UE may not send the PUCCH to the network when a HARQ-ACK information bit corresponding to the data channel has a NACK value or the HARQ-ACK information bits corresponding to all the data channels have NACK value. In a third example, the UE may send a PUCCH carrying HARQ-ACK information corresponding to the data channel to the network regardless of a value of the HARQ-ACK information.

For example, the network may configure a feedback mode for the UE. The feedback mode may include at least ACK-only feedback mode and ACK/NACK feedback mode. For ACK-only feedback mode, the UE may transmit PUCCH only when the UE decodes the at least one PDSCH or PSSCH correctly (e.g., the HARQ-ACK information bit corresponding to the at least one PDSCH or PSSCH has ACK value). For example, the UE may not transmit PUCCH when the UE does not decode the PDSCH or PSSCH correctly (e.g., the HARQ-ACK information bit corresponding to the PDSCH or PSSCH has NACK value or the HARQ-ACK information bits corresponding to all the PDSCHs or PSSCHs are NACK values).

For ACK/NACK-only feedback mode, the UE may transmit PUCCH to carry the HARQ-ACK information regardless of whether the UE decodes the PDSCH or PSSCH correctly or not (e.g., the HARQ-ACK information bit value). When the UE decodes a transport block correctly or detects a CI indicating an SPS PDSCH or SPS PSSCH release, the UE may generate HARQ-ACK information with ACK value. Otherwise, the UE may generate HARQ-ACK information with NACK value.

In some cases, the network may configure the UE with the feedback mode via radio resource control (RRC) signaling, medium access control element (MAC CE), or CI. The feedback mode may correspond to (e.g., is associated with) data carried by the PDSCH, PUSCH or PSSCH. For example, the ACK-only feedback may correspond to the data of remote UE. The ACK/NACK feedback may correspond to the data of aggregated UE. For example, if the PDSCH carries the data of remote UE, then the ACK-only feedback may be used for the PDSCH. If the PDSCH carries the data of aggregated UE, then the ACK/NACK feedback may be used for the PDSCH.

Alternatively, the CI may indicate the owner of the data carried by the scheduled PDSCHs, PUSCHs or PSSCHs as well as the feedback mode. For example, the field included in the CI, the radio network temporary identifier of the CI, the search space index of the CI, or the control resource set index of the CI may be used to indicate the owner of the data carried by the scheduled PDSCHs, PUSCHs or PSSCHs as well as the feedback mode. For example, the CI may indicate that the scheduled PDSCH carries the downlink data of the remote UE and ACK-only feedback is applied for the PDSCH. Alternatively, the CI may indicate that the scheduled PDSCH carries the downlink data of the aggregated UE and ACK/NACK feedback is applied for the PDSCH. Additionally, the CI may indicate that the scheduled PSSCH carries the sidelink data of the remote UE and ACK-only feedback is applied for the PSSCH. Alternatively, the CI may indicate that the scheduled PSSCH carries the sidelink data of the aggregated UE and ACK/NACK feedback is applied for the PSSCH.

In some embodiments, the ACK-only feedback mode may be applied to one or more PDSCHs for a UE. A PUCCH resource for ACK-only feedback may overlap with another PUCCH transmission or a PUSCH transmission at least in the time domain. In this case, the UE may transfer the ACK-only mode to the ACK/NACK feedback mode for the one or more PDSCHs. For example, the UE may use the ACK/NACK feedback for the one or more PDSCHs. The UE may generate HARQ-ACK information with ACK or NACK for the one or more PDSCHs in accordance with the embodiments.

In some embodiments, at least a first PUCCH corresponding to ACK-only feedback mode may overlap with a second PUCCH corresponding to ACK-only feedback mode in the time domain. The first PUCCH may carry the first HARQ-ACK information. The second PUCCH may carry the second HARQ-ACK information. The UE may multiplex the first HARQ-ACK information and the second HARQ-ACK information. The UE may select the PUCCH resource according to the HARQ-ACK information after multiplexing. The UE may transmit the selected PUCCH resource.

For example, the network 402 may configure a plurality of PUCCH resources. The mapping between the HARQ-ACK information and the PUCCH resource is shown in Table 1, below. The UE may select the PUCCH resource according to the mapping relationship. If the HARQ-ACK information is {1}, {1,0}, {1,0,0}, or {1,0,0,0}, the UE may select the first PUCCH resource in the plurality of PUCCH resources. If the HARQ-ACK information is {0,1}, {0,1,0}, or {0,1,0,0}, the UE may select the second PUCCH resource in the plurality of PUCCH resources, and so on. In either case, the UE may transmit the selected PUCCH resource to indicate the network the corresponding HARQ-ACK information.

TABLE 1
HARQ-ACK information

| | | | | |
|---|---|---|---|---|
| {1} | {1, 0} | {1, 0, 0} | {1, 0, 0, 0} | 1^{st} resource |
| | {0, 1} | {0, 1, 0} | {0, 1, 0, 0} | 2^{nd} resource |
| | {1, 1} | {1, 1, 0} | {1, 1, 0, 0} | 3^{rd} resource |
| | | {0, 0, 1} | {0, 0, 1, 0} | 4^{th} resource |
| | | {1, 0, 1} | {1, 0, 1, 0} | 5^{th} resource |
| | | {0, 1, 1} | {0, 1, 1, 0} | 6^{th} resource |
| | | {1, 1, 1} | {1, 1, 1, 0} | 7^{th} resource |
| | | | {0, 0, 0, 1} | 8^{th} resource |
| | | | {1, 0, 0, 1} | 9^{th} resource |
| | | | {0, 1, 0, 1} | 10^{th} resource |
| | | | (1, 1, 0, 1} | 11^{th} resource |
| | | | {0, 0, 1, 1} | 12^{th} resource |
| | | | {1, 0, 1, 1} | 13^{th} resource |
| | | | {0, 1, 1, 1} | 14^{th} resource |
| | | | {1, 1, 1, 1} | 15^{th} resource |

In some embodiments, the network may transmit a CI for scheduling PUSCH, PDSCH or PSSCH for a UE (e.g., a remote UE or an aggregate UE). If more than one data channels are within a time interval, then the more than one data channels may carry the same transport block. For example, a first data channel and a second data channel may be configured with a time interval and carry a same transport block. Additionally, or alternatively, if more than one data channels are within the time interval and have the same HARQ process number, then the more than one data channels may carry the same transport block. For example, the first data channel and the second data channel may have the same HARQ process number and carry a same transport block.

In some cases, the time interval may be configured by the network or specified by a protocol. The time interval may include one or more slots, OFDM symbols, frames, or milliseconds. The data channels may include PDSCH, PUSCH, or PSSCH. Each of the more than one data channels may be for an aggregated UE or a remote UE.

In some cases, PUSCH 502, PUSCH 504, and PUSCH 506 are transmitted within the time interval 508. In some examples, the various PUSCHs 502, 504, and 506 may include various HARQ processing numbers (HPNs). For example, PUSCH 502 may include a HPN 5. PUSCH 504 may include HPN 3. PUSCH 506 may include HPN 3. Therefore, PUSCH 504 and PUSCH 506 may carry the same transport block because they are within the configured time interval 508 and have the same HPN. PUSCH 502 may carry a different transport block from PUSCH 504 and PUSCH 506 because PUSCH 502 has a different HPN than the HPN of PUSCH 504 and 506.

FIG. 6 is a diagram illustrating an example CI 600, according to various arrangements. The CI 600 may be an example, of a DCI or an SCI, in accordance with the various embodiments described herein with reference to FIGS. 1-5. The CI may include a first information block 602 and a second information block 608. In some cases, the second information block 608 may include a first sub-block 604 and a second sub-block 606. A network and a UE as referred to herein may be respective examples of a network 402 and a UE 404, 406, or 408, as described with reference to FIG. 4.

In some embodiments, the network may configure an RNTI for at least a UE (e.g., an aggregated UE or a remote UE). In some cases, the RNTI may be used for scrambling the CI 600. Multiple UEs may be able to monitor and detect the CI 600. The same RNTI may be configured for the UEs, where the UEs may include, an aggregated UE, a remote UE, or another type of UE.

In some examples, the CI 600 may schedule at least a PUSCH, PDSCH or PSSCH for the UEs. Alternatively, the CI 600 may schedule more than one PUSCH, PDSCH or PSSCH for each of the UEs. For example, the UEs may include two UEs. One UE may be a remote UE and the other UE may be an aggregated UE. The CI 600 may schedule two PUSCHs. The first PUSCH may be for the aggregated UE and the second PUSCH may be for the remote UE.

In some embodiments, the UE may detect (e.g., monitor) the CI 600 within a search space. For example, the network may configure multiple search spaces for the UE. A search space may be associated with a RNTI. Alternatively, a search space may be associated with more than one RNTIs, and vice versa. In some cases, the association relationship may be configured by the network. The UE may monitor the CI 600 scrambled with an RNTI only in the associated search space. For example, the UE may only monitor the CI 600 scrambled with the associated RNTI in a search space.

For example, three RNTIs may be configured for a first UE and denoted by RNTI 1, RNTI 2, RNTI 3, respectively. RNTI 1 and RNTI 3 may be associated with search space 1. RNTI 2 may be associated with search space 2. Therefore, the first UE may only monitor CI 600 scrambled with RNTI 1 or RNTI 3 in the search space 1. UE 1 may only monitor CI 600 scrambled with RNTI 2 in the search space 2. In some cases, two search spaces may be configured for a first UE and denoted by search space 1 and search space 2, respectively.

A control resource set (CORESET) may include at least a resource location and size in the frequency domain for a UE (e.g., a remote UE or an aggregate UE) to monitor CI 600. The network may configure a multiple CORESETs for the UE. In some cases, a CORESET may be associated with an RNTI. Alternatively, a CORESET may be associated with more than one RNTI and vice versa. The association relationship may be configured by the network. The UE may monitor the CI 600 scrambled with an RNTI only in the associated CORESET. For example, in a CORESET, the UE may only monitor the CI 600 scrambled with the associated RNTI.

For instance, three CORESETs may be configured by the network for the UE and denoted by CORESET 1, CORESET 2, and CORESET 3, respectively. RNTI 1 and RNTI 3 may be associated with CORESET 1. RNTI 2 may be associated with CORESET 2 and CORESET 3. Therefore, the UE may only monitor CI 600 scrambled with RNTI 1 or RNTI 3 in CORESET 1. The UE may only monitor CI 600 scrambled with RNTI 2 in CORESET 2 or CORESET 3.

In some cases, the size of the CI 600 for scheduling PUSCH, PDSCH or PSSCH may be configured by the network. For example, the CI 600 may include a first type of field. The network may configure the size of the first type of field for multiple UEs. The first type of field may be common for the UEs. The UEs may determine a same value indicated by the first type of field. In some examples, the CI 600 may include a second type of field. The second type of field may be specific to one of the UEs.

In some cases, the CI 600 may include multiple information blocks. The first information block 602 may include the first type of fields. The second information block 608 may include multiple sub-blocks. Each of the sub-blocks 604 and 606 may include the second type of fields. Each of the sub-blocks 604 and 606 may be specific (e.g., correspond) to only one of the UEs. For example, the first information block 602 may be configured commonly for a first UE and a second UE (e.g., wireless communication devices) and the second information block 608 includes at least the first sub-block 604 configured specifically for the first UE and the second sub-block 606 configured specifically for the second UE.

In some cases, the network may configure a start and length of the corresponding sub-blocks for each of the UEs. For example, the network (e.g., a wireless node) may configure at least one of a starting bit and a length of each of the first sub-block 604 and the second sub-block 606. The start of the sub-block (e.g., the sub-block 604 or 606) may include a position for the first bit of the sub-block in the CI 600. The length of the sub-block may include a number of bits for the sub-block. In some cases, a sub-block may include all of the second type of fields for the corresponding UE.

In some cases, the first information block 602 (e.g., the first type of field) may include at least one of an identifier for CI format, carrier indicator, uplink (UL)/supplementary uplink (SUL) indicator, frequency domain resource allocation, time domain resource allocation, frequency hopping, priority indicator, invalid symbol pattern indicator, channel access CPext, virtual resource block (VRP)-to-physical resource block (PRB) mapping, PRB bundling size indicator, rate matching indicator, or ZP CSI-RS trigger.

If the frequency domain resource allocation and time domain resource allocation are the first type of fields, then a same resource may be allocated for the data channels for the UEs. In some cases, the UEs may be configured with different antenna ports.

In some cases, the network may configure whether at least one of the following fields is the first type of field or the second type of field. The fields may include modulation and coding scheme (MCS), new data indicator (NDI), redundancy version (RV), HPN, SRS request, SRS offset indicator, PUCCH resource indicator (PRI), PDSCH-to-HARQ_feedback timing indicator, transmission configuration indication (TCI), CBG (code block group) transmission information (CBGTI), downlink assignment indicator (DAI), transmission power command (TPC) for the scheduled PUSCH, SRS resource set indicator, SRS resource indicator, preceding information and number of layers, Antenna ports, PTRS-DMRS association, beta_offset indicator, DMRS sequence initialization, UL-SCH indicator, CSI request, open-loop power control parameter set indication, TPC for PUCCH, One-shot HARQ-ACK request, enhanced Type-3 codebook indicator, PDSCH group index, new feedback indicator, number of request PDSCH groups, HARQ-ACK retransmission indicator, CBG flushing out information (CBGFI), or PUCCH cell indicator.

Additionally, or alternatively, the second information block 608 (e.g., the second type of field) may include at least one of a DAI, TPC for the scheduled PUSCH, SRS resource set indicator, SRS resource indicator, preceding information and number of layers, Antenna ports, PTRS-DMRS association, beta_offset indicator, DMRS sequence initialization, UL-SCH indicator, CSI request, Open-loop power control parameter set indication, TPC for PUCCH, One-shot HARQ-ACK request, Enhanced Type-3 codebook indicator, PDSCH group index, New feedback indicator, Number of request PDSCH groups, HARQ-ACK retransmission indicator, CBGFI, or PUCCH cell indicator.

In some embodiments, when at least one of MCS, NDI, RV, and CBGTI belong to the first type of field or is common for the UEs, the data channels scheduled by the CI 600 may carry a same transport block (or MAC PDU). Otherwise, the data channels scheduled by the CI 600 may carry different transport blocks (or MAC PDUs). In some embodiments, when at least one of MCS, NDI, RV belong to the first type of field or is common for the UEs, the ACK-only feedback mode may be applied for the UEs. Otherwise, the ACK/NACK feedback mode may be applied for the UEs.

In some cases, the network may configure the CI 600 for a first UE and a second UE. The first information block 602 of the CI 600 may start from the first bit (e.g., a1) of the CI 600. The first information block 602 may include the first type of fields. The network may configure the first type of fields to include one or more identifiers of CI 600 formats, frequency domain resource allocation, time domain resource allocation, and/or VRB-to-PRB mapping. In some cases, the number of bits for these fields may be 1, 13, 4, and 1, respectively (e.g., based on a configuration or a definition in the protocol). The first information block may include 18 bits, starting from a1 to a18.

The second information block 608 of the CI 600 may include two sub-blocks. The first sub-block 604 (e.g., sub-block 1) may be for the first UE and the second sub-block 606 (e.g., sub-block 2) may be for the second UE. The network may configure that the second types of fields include MCS, NDI, RV, HPN, DAI, antenna port(s), PUCCH resource indicator, TPC for PUCCH, and/or PDSCH-to-HARQ feedback timing indicator for UE 1 and UE 2. In some cases, the number of the bits for the second types of fields may be 5, 1, 2, 4, 2, 4, 3, 2, and 3 bits, respectively, for the first UE and the second UE (e.g., based on a configuration or a definition in the protocol). The first sub-block 604 (e.g., sub-block 1) or the second sub-block 606 (e.g., sub-block 2) may include 26 bits.

In some cases, the network may configure the starting bit of the first sub-block 604 (e.g., sub-block 1) for the first UE to be a19. In this case, the first sub-block 604 (e.g., sub-block 1) may include a19, a20, . . . , a44. The network may configure the starting bit of the second sub-block 606 (e.g., sub-block 2) for UE 2 to be a45. In this case, the second sub-block (e.g., sub-block 2) may include a45, a46, . . . , a70.

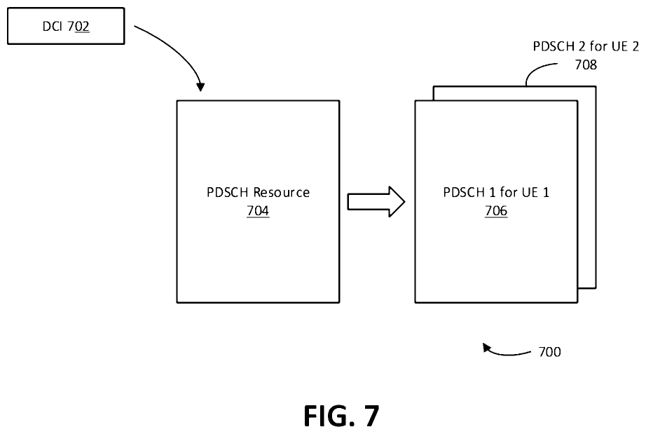

FIG. 7 is a diagram illustrating an example PDSCH scheduling 700, according to various arrangements. The PDSCH scheduling 700 may be scheduled by a network via a CI 702 (e.g., DCI or SCI). In some cases, the CI 702 may indicate PDSCH resource for each UE. For example, the CI 702 may indicate a first PDSCH resource set 706 for a first UE and a second PDSCH resource set 708 for a second UE. The network may allocate a same resource in both the time domain and the frequency domain for both the first UE and the second UE. For instance, the CI 702 may schedule two PDSCHs. PDSCH 706 and PDSCH 708 may occupy the same resource. The first UE may only demodulate PDSCH 706, and the second UE may only demodulate PDSCH 708. In some cases, the CI 702 may indicate antenna ports 0, 1 for the first UE and antenna ports 2, 3 for the second UE. Antenna port 0, 1 may be used for PDSCH 706 transmission. Antenna port 2, 3 may be used for PDSCH 708 transmission.

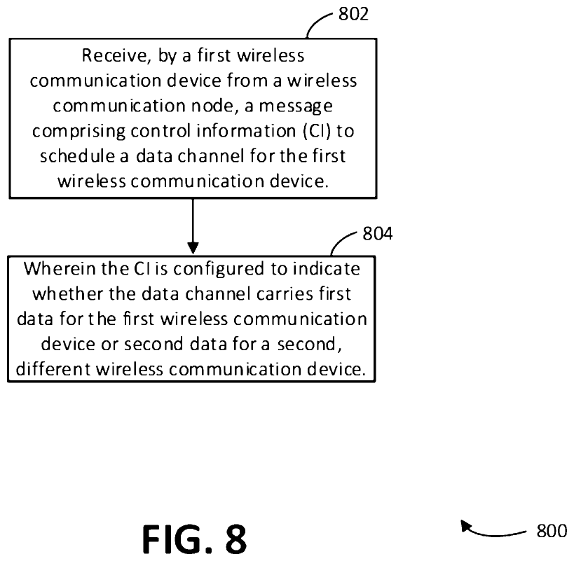

FIG. 8 is a flowchart diagram illustrating an example method 800 for information transmission, according to various arrangements. In some cases, the method 800 may include configurations for a CI message to indicate whether a data channel for a first wireless communication device carries data for the first wireless communication device or data for a second wireless communication device.

At 802, a first wireless communication device may receive, from a wireless communication node, a message comprising CI to schedule a data channel for the first wireless communication device. At 804, the CI is configured to indicate whether the data channel carries first data for the first wireless communication device or second data for a second, different wireless communication device. In some cases, the first wireless communication device may be a first UE (e.g., a remote UE, an aggregate UE, or another type of UE) and the second wireless communication device may be a second UE (e.g., a remote UE, an aggregate UE, or another type of UE). In some examples, the CI may be an example of a DCI or an SCI.

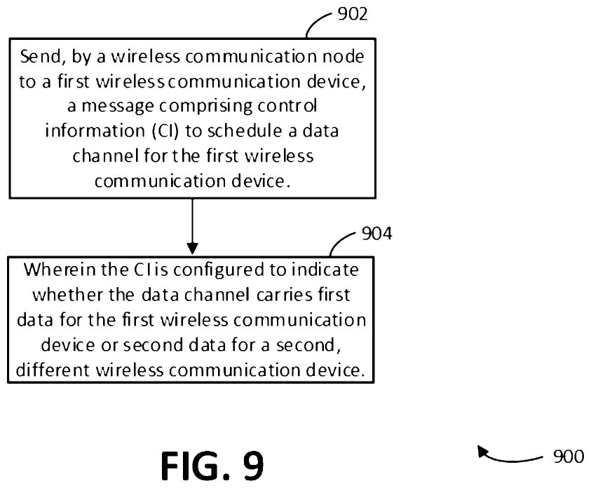

FIG. 9 is a flowchart diagram illustrating an example method 900 for information transmission, according to various arrangements. In some cases, the method 900 may include configurations for a CI message to indicate whether a data channel for a first wireless communication device carries data for the first wireless communication device or data for a second wireless communication device.

At 902, a wireless communication node may send, to a first wireless communication device, a message comprising CI to schedule a data channel for the first wireless communication device. At 904, the CI is configured to indicate whether the data channel carries first data for the first wireless communication device or second data for a second, different wireless communication device. In some cases, the first wireless communication device may be a first UE (e.g., a remote UE, an aggregate UE, or another type of UE) and the second wireless communication device may be a second UE (e.g., a remote UE, an aggregate UE, or another type of UE). In some examples, the CI may be an example of a DCI or an SCI.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
receiving, by a first wireless communication device from a wireless communication node, a message comprising Control Information (CI) to schedule a data channel for the first wireless communication device; wherein
the CI is configured to indicate whether the data channel carries first data for the first wireless communication device or second data for a second, different wireless communication device.

2. The wireless communication method of claim 1, wherein the CI includes a Radio Network Temporary Identifier (RNTI), a first field, a CORESET index, or a search space index configured to indicate whether the data channel carries the first data or the second data.

3. The wireless communication method of claim 1, wherein when the CI indicates that the data channel carries the second data, the method further comprises:
requesting, by the first wireless communication device, the second wireless communication device to generate a transport block for the data channel.

4. The wireless communication method of claim 1, wherein when the CI indicates that the data channel carries the second data, the method further comprising:
after the transport block is decoded by the first wireless communication device, transmitting, by the first wireless communication device to the second wireless communication device, the decoded transport block.

5. The wireless communication method of claim 1, wherein when the CI indicates that the data channel carries the second data, the method further comprising:
sending, by the first wireless communication device to the wireless communication node, PUCCH only when a HARQ-ACK information bit corresponding to the at least one data channel has an ACK value.

6. The wireless communication method of claim 1, wherein when the CI indicates that the data channel carries the second data, the method further comprising:
not sending, by the first wireless communication device to the wireless communication node, PUCCH when a HARQ-ACK information bit corresponding to the data channel has a NACK value or the HARQ-ACK information bits corresponding to all the data channels have NACK value.

7. The wireless communication method of claim 1, wherein when the CI indicates that the data channel carries the first data, the method further comprises:
sending, by the first wireless communication device to the wireless communication node, PUCCH carrying HARQ-ACK information corresponding to the data channel, regardless of a value of the HARQ-ACK information.

8. The wireless communication method of claim 1, wherein when the CI indicates that the data channel carries the first data, the method further comprises:
after successfully decoding a transport block the data channel, sending, by the first wireless communication device, the decoded transport block to a higher layer of the first wireless communication device.

9. The wireless communication method of claim 1, wherein the CI includes a second field configured to indicate the first wireless communication device to retransmit a transport block through the data channel, and wherein the transport block was delivered to the second wireless communication device from the first wireless communication device.

10. The wireless communication method of claim 9, wherein a first HARQ process, corresponding to the first wireless communication device, is associated with a second HARQ process, corresponding to the second wireless communication device.

11. The wireless communication method of claim 1, wherein the data channel and at least a second data channel are configured with a time interval, the data channel and the second data channel carry a same transport block.

12. The wireless communication method of claim 11, wherein the data channel and the second data channel have the same HARQ process number.

13. The wireless communication method of claim 1, wherein the CI includes at least a first information block and a second information block, and wherein the first information block is configured commonly for the first and second wireless communication devices, while the second information block has at least a first sub-block configured specifically for the first wireless communication device and a second sub-block configured specifically for the second wireless communication device.

14. The wireless communication method of claim 13, wherein at least one of a starting bit and a length of each of the first sub-block and the second sub-block is configured by a wireless communication node.

15. The wireless communication method of claim 13, wherein
the first information block includes at least one of identifier for control information format, carrier indicator, frequency domain resource allocation, time domain resource allocation, frequency hopping, priority indicator; and
the second information block includes at least one of transmission power command (TPC), preceding information and number of layers, antenna ports.

16. A wireless communication method, comprising:
sending, by a wireless communication node to a first wireless communication device, a message comprising Control Information (CI) to schedule a data channel for the first wireless communication device; wherein
the CI is configured to indicate whether the data channel carries first data for the first wireless communication device or second data for a second, different wireless communication device.

17. A wireless communications apparatus comprising a processor and a memory, wherein the processor is configured to read code from the memory and implement a wireless communication method, the method comprising:
receiving, by a first wireless communication device from a wireless communication node, a message comprising Control Information (CI) to schedule a data channel for the first wireless communication device; wherein
the CI is configured to indicate whether the data channel carries first data for the first wireless communication device or second data for a second, different wireless communication device.

18. A computer program product comprising a computer-readable program medium code stored thereupon, the code, when executed by a processor, causing the processor to implement the wireless communication method of claim 1.

19. A wireless communications apparatus comprising a processor and a memory, wherein the processor is configured to read code from the memory and implement the wireless communication method of claim 16.

20. A computer program product comprising a computer-readable program medium code stored thereupon, the code, when executed by a processor, causing the processor to implement the wireless communication method of claim 16.
